(19) United States
(12) Patent Application Publication
(10) Pub. No.: US 2026/0330884 A1
(43) Pub. Date: Oct. 22, 2026

(54) Oil Change Notification System

(71) Applicant: Garland Wesley Kejick, Kejick (CA)

(72) Inventor: Garland Wesley Kejick, Kejick (CA)

(21) Appl. No.: 19/181,406

(22) Filed: Apr. 17, 2025

(51) Int. Cl. G07C 5/00; B60K 35/22; G01C 22/00; G01V 3/02; G07C 5/08

(52) U.S. Cl. CPC G07C 5/006; B60K 35/22; G01C 22/00; G01V 3/02; G07C 5/0825

(57) ABSTRACT

An oil change notification light system is provided. The oil change notification light system includes an interface, a light indicator assembly including a green light, a yellow flashing light, and a red light, a mileage tracking module, and a continuity sensor integrated into an oil plug. The mileage tracking module monitors traveled distance using an odometer sensor and a computer chip, while the continuity sensor detects oil change events based on removal or reinstallation of the oil drain plug. A data processing unit activates the appropriate light based on preset distance thresholds, and communicates with an engine control module for data storage. A manual reset button is also included as an alternative reset mechanism.

### BACKGROUND OF THE INVENTION

The present invention pertains to automotive maintenance systems, and more particularly, to electronic systems that monitor engine oil conditions and provide progressive visual alerts to the vehicle operator to encourage timely oil changes and prevent engine damage.

Conventional automobiles rely heavily on rudimentary oil change reminders such as windshield decals, manual logs, or basic dashboard icons triggered by fixed mileage intervals. These methods are widely acknowledged to be unreliable due to their dependence on manual resets and their passive, non-urgent presentation. As a result, many vehicle operators either neglect or delay oil changes, inadvertently accelerating engine wear and increasing the risk of catastrophic engine failure.

To address this, some vehicle manufacturers have integrated oil life monitoring systems that estimate the condition of engine oil based on factors such as mileage, engine load, temperature, and driving behavior. However, these systems often rely on proprietary software algorithms embedded within the vehicle's engine control module (ECM), which can be opaque to users, difficult to reset, or incompatible with older vehicle models. Additionally, these systems typically do not provide a graduated warning structure with clear, user-intuitive alerts that escalate in urgency as the need for maintenance becomes critical.

Furthermore, many current systems lack integration with the vehicle's odometer or dashboard display in a manner that is conspicuous and easily interpretable. This results in suboptimal user engagement, as drivers may miss or misunderstand oil maintenance prompts. Moreover, current solutions typically do not incorporate real-time hardware sensors positioned at the oil plug or pan level to detect changes or confirm maintenance events, leaving room for false alerts or failure to detect missed oil changes.

Therefore, there exists a need in the art for a reliable, visible, and functionally integrated system that can monitor oil maintenance intervals and deliver real-time, escalating notifications. The present invention is configured to reduce reliance on user memory or third-party reminders and eliminate ambiguities associated with software-only monitoring.

In light of the devices disclosed in the known art, it is submitted that the present invention substantially diverges in design elements and methods from the known art and consequently it is clear that there is a need in the art for an improvement for an oil change notification light system. In this regard the instant invention substantially fulfills these needs.

### SUMMARY OF THE INVENTION

In view of the foregoing disadvantages inherent in the known types of oil change notification light systems now present in the known art, the present invention provides a new oil change notification light system wherein the same can be utilized to provide a tiered, highly visible, and reliable method for alerting drivers to upcoming and overdue oil maintenance, reducing the risk of engine damage due to missed oil changes.

It is an objective of the present invention to provide an oil change notification light system that delivers progressive visual alerts to the vehicle operator indicating the status of the engine oil. The system includes a green indicator for normal oil condition, a yellow flashing indicator for scheduled maintenance, and a red indicator for critical overdue oil changes.

It is an objective of the present invention to provide an oil change notification light system incorporating a mileage tracking module configured to monitor distance traveled since the last oil change event. The mileage tracking module comprises an odometer sensor and a counter mileage computer chip sensor. This configuration enables accurate tracking of maintenance intervals based on actual vehicle usage.

It is an objective of the present invention to provide an oil change notification light system that utilizes a continuity sensor located at the oil plug or oil pan to detect removal or reinstallation of the oil drain plug. The continuity sensor serves to confirm the occurrence of an oil change event. The continuity sensor is adapted to eliminate the need for manual resets by enabling automatic reset of the system upon confirmation of plug removal.

It is an objective of the present invention to provide an oil change notification light system integrated with a computer gauge interface that displays the light indicators in a prominent location on the vehicle dashboard. The interface is configured to be compatible with both analog and digital odometer systems.

It is an objective of the present invention to provide an oil change notification light system comprising a reset mechanism accessible to the vehicle operator. The system includes a manual reset button located on the dashboard or steering wheel.

It is an objective of the present invention to provide an oil change notification light system including a data input module for communication with the engine control module (ECM). The data input module stores and transmits sensor outputs and mileage data to the ECM for centralized vehicle diagnostics and long-term maintenance tracking. This integration enhances the utility and accuracy of the vehicle's onboard diagnostic systems.

It is an objective of the present invention to provide an oil change notification light system including a circuit breaker and fuse assembly to ensure safe operation and electrical protection of system components. The circuit breaker and fuse prevent damage to the light indicators, sensors, and wiring due to voltage surges or electrical faults.

It is therefore an object of the present invention to provide a new and improved oil change notification light system comprising that has all of the advantages of the known art and none of the disadvantages.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a perspective view of an embodiment of the dashboard display of the oil change notification system.

FIG. 2 shows a block diagram of an embodiment of the oil change notification system.

### DETAILED DESCRIPTION OF THE INVENTION

Reference is made herein to the attached drawings. For the purpose of presenting a brief and clear description of the present invention, the preferred embodiment will be discussed as used to provide a tiered, highly visible, and reliable method for alerting drivers to upcoming and overdue oil maintenance, reducing the risk of engine damage due to missed oil changes. The figures are intended for representative purposes only and should not be considered to be limiting in any respect.

Reference will now be made in detail to the exemplary embodiment(s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment”, “first embodiment”, “second embodiment”, or “third embodiment” does not necessarily refer to the same embodiment.

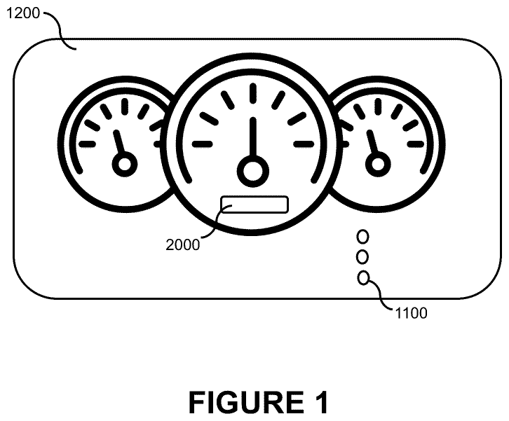

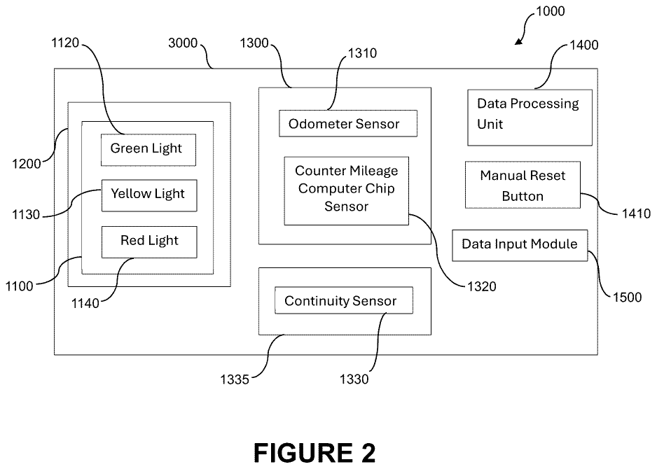

Referring now to FIGS. 1 and 2, there is shown a perspective view of an embodiment of the dashboard display of the oil change notification system and a block diagram of an embodiment of the oil change notification system, respectively. The oil change notification system 1000 includes a light indicator assembly 1100 comprising three distinct light elements—a first color light, a second color light configured to flash, and a third color light—each adapted to signal engine oil condition based on traveled mileage since the last oil change. In the illustrated embodiment, the first color light is a green light 1120, the second color light is a yellow light 1130 and the third color light is a red light 1140. The lights are integrated into a computer gauge interface 1200, which may be positioned above or below the odometer in analog systems or configured to illuminate the odometer digits 2000 in digital displays. In some embodiments, the light indicator assembly 1100 may comprise any suitable colored light capable of producing clear visual signals. In certain configurations, the assembly includes three discrete light elements as shown, whereas in alternate embodiments, a single multi-color light element is provided, which is adapted to illuminate in three different colors corresponding to different oil maintenance conditions. The oil change notification system 1000 is configured to enhance vehicle maintenance compliance and reduce engine wear or failure due to missed oil changes. The oil change notification system 1000 is configured to be installed within a vehicle 3000.

The oil change notification system 1000 further comprises a mileage tracking module 1300, which includes an odometer sensor 1310 and a counter mileage computer chip sensor 1320. The odometer sensor 1310 is configured to detect vehicle movement by monitoring the rotation of the vehicle's wheels or transmission components. In one embodiment, the sensor 1310 employs a magnetic or optical detection mechanism to generate electrical pulses corresponding to wheel rotations. Each pulse represents a specific unit of distance traveled, enabling the calculation of accumulated mileage. The counter mileage computer chip sensor 1320 is designed to record the distance traveled since the last system reset. The counter mileage computer chip sensor 1320 interfaces with the vehicle's data processing unit to continuously evaluate whether predefined mileage thresholds have been reached, triggering the appropriate maintenance alerts when necessary. By maintaining a separate count of the distance traveled, the counter mileage computer chip sensor 1320 provides a means to cross-verify the data obtained from the odometer sensor. The integration of both sensors allows the system to cross-reference data, ensuring that any anomalies or errors from one sensor can be detected and corrected using information from the other. This dual-sensor approach enhances the reliability of the mileage tracking module, ensuring timely and accurate maintenance alerts for the vehicle operator.

In one embodiment, the oil change notification system 1000 is designed with customizable maintenance thresholds to accommodate various vehicle types, driving habits, and manufacturer recommendations. For instance, a first threshold may be set at approximately 10,000 kilometers, prompting the activation of a yellow light that flashes intermittently—particularly during engine start and operation—to alert the driver of an upcoming oil change requirement. If an oil change is not confirmed and the vehicle continues to operate, a second threshold at approximately 30,000 kilometers triggers the illumination of a red light, indicating a critical maintenance condition. These thresholds can be manually adjusted or preset based on specific factors. For example, vehicles operating under severe driving conditions—such as frequent short trips, extensive idling, or driving in extreme temperatures—may require more frequent oil changes, and the system can be configured to reflect these needs by setting lower thresholds. Conversely, vehicles primarily used for long-distance highway driving under optimal conditions may have higher thresholds. This adaptability ensures that the oil change notification system 1000 provides timely and appropriate maintenance alerts, thereby promoting engine longevity and optimal performance.

In the illustrated embodiment, the oil change notification system 1000 further comprises a continuity sensor 1330 operably positioned at the oil drain plug 1335 or oil pan. The continuity sensor 1330 is configured to monitor electrical continuity through the plug 1335 and detects changes when the plug 1335 is removed and reinstalled, thereby confirming the occurrence of an oil change event. The continuity sensor 1330 provides an automatic reset signal to the mileage tracking module 1300 and a data processing unit 1400, ensuring the light indicator assembly 1100 is appropriately cleared and reinitialized. The oil change notification system 1000 optionally includes a manual reset button 1410 mounted on the vehicle's dashboard or integrated into the steering wheel assembly. This manual input allows the vehicle operator to reset the oil change notification system 1000 in the event of sensor malfunction or alternative maintenance verification methods.

In some embodiments, the invention further comprises a data input module 1500 configured to interface with the vehicle's engine control module (ECM). The data input module 1500 is configured to receive and store operational data including mileage, sensor output, and reset confirmations. Data from the data input module 1500 is used for centralized diagnostic reporting, maintenance history logging, or future software-based analytics. The integration allows the oil change notification system 1000 to access and monitor real-time engine parameters such as mileage, engine load, temperature, and operating conditions. By analyzing this data, the oil change notification system 1000 can accurately assess the degradation rate of engine oil, enabling it to provide timely alerts for oil changes based on actual usage rather than fixed intervals.

In some embodiments, the oil change notification system 1000 includes a circuit breaker and fuse assembly integrated within the vehicle's electrical system. The circuit breaker is configured to protect against voltage surges and electrical faults that may otherwise compromise the integrity of the gauge interface, light indicators, sensors, or data modules.

In one exemplary embodiment, the oil change notification light system 1000 is installed during vehicle manufacture. Installation comprises mounting the gauge interface 1200, connecting the odometer sensor and counter chip to the vehicle's drive train sensor network, securing the continuity sensor to the oil pan plug location, and linking all components via appropriate wiring harnesses protected by the circuit breaker and fuse. Upon vehicle initialization, the oil change notification system 1000 defaults to green light 1120 status. After traveling 10,000 kilometers without a confirmed oil change event, the system automatically transitions to yellow light 1130 mode, with flashing behavior programmed into the indicator logic. If no reset or continuity event is detected, the system activates the red light 1140 upon reaching 30,000 kilometers from the last reset or plug event. The operator may manually reset the oil change notification system 1000 via the designated reset button or complete an oil change to trigger the continuity sensor and automatically reset the system.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, device and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An oil change notification system for a motor vehicle, comprising:
a light indicator assembly including a green light, a yellow light, and a red light configured to provide visual oil maintenance alerts;
an interface operably connected to a vehicle dashboard display, the interface configured to display the light indicator assembly;
a mileage tracking module including an odometer sensor and a counter mileage computer chip sensor configured to measure a traveled distance since a most recent oil change event;
an oil plug sensor configured to detect removal or installation of an oil drain plug;
a data processing unit configured to receive input from the mileage tracking module and the oil plug sensor, and to activate the green light when the traveled distance is within a first threshold, to deactivate the green light and to activate the yellow light when the distance exceeds the first threshold, and to deactivate the yellow and to activate the red when the distance exceeds a second threshold beyond the first threshold;
a data input module configured to store and transmit sensor data to an engine control module (ECM).

2. The oil change notification system of claim 1, wherein the green light indicates normal engine oil operation within 10,000 kilometers of travel.

3. The oil change notification system of claim 1, wherein the first threshold is 10,000 km, whereupon the yellow light flashes periodically.

4. The oil change notification system of claim 1, wherein the second threshold is 30,000 kilometers, whereupon the red light activates after the yellow light has been deactivated.

5. The oil change notification system of claim 1, wherein the light indicator assembly is positioned above or below an odometer output on the vehicle dashboard display.

6. The oil change notification system of claim 1, further comprising a circuit breaker and fuse module configured to protect the electrical system of the light indicator assembly from overcurrent conditions.

7. The oil change notification system of claim 1, wherein the data processing unit comprises a microcontroller integrated into the engine control module.

8. The oil change notification system of claim 1, wherein the mileage tracking module is configured to synchronize with the ECM's internal mileage records to ensure redundancy and accuracy.

9. The oil change notification system of claim 1, wherein the yellow light is configured to flash intermittently to draw driver attention.

10. The oil change notification system of claim 9, wherein a user-reset button is located on a steering wheel or a dashboard gauge cluster.

11. The oil change notification system of claim 1, further comprising a continuity sensor associated with the oil plug for detecting completion of an oil change event.

12. The oil change notification system of claim 11, wherein the continuity sensor eliminates the need for a manual reset button by automatically detecting oil changes through interruption of continuity at the oil drain plug.

13. The oil change notification system of claim 11, wherein the oil change notification system is reset upon either activation of a user-reset button or detection of oil plug removal via the continuity sensor.

14. The oil change notification system of claim 1, wherein the odometer sensor is configured to detect vehicle movement by monitoring transmission component rotations, and the counter mileage computer chip sensor is configured to record distance traveled since a last system reset, the system further comprising a data processing unit configured to cross-reference data from both sensors to detect discrepancies.
